(19) United States
(12) Patent Application Publication
(10) Pub. No.: US 2018/0298666 A1
(43) Pub. Date: Oct. 18, 2018

(54) Sliding Door Arrangement

(71) Applicant: Elfa International AB, Vastervik (SE)

(72) Inventors: Johan Andersson, Vastervik (SE); Peter Elf, Mullsjo (SE)

(21) Appl. No.: 15/767,350

(22) PCT Filed: Oct. 12, 2016
(86) PCT No.: PCT/SE2016/050980

§ 371 Date: Apr. 10, 2018

(30) Foreign Application Priority Data
Oct. 15, 2015 (SE) 1551335-1

(51) Int. Cl. E05F 5/00; E05F 1/16

(52) U.S. Cl. CPC E05F 5/003; E05F 1/16; E05Y 2900/132; E05Y 2201/412; E05Y 2201/408

(57) ABSTRACT

The present disclosure relates to a sliding door arrangement comprising at sliding door (1), the sliding motion of which is guided by a rail (7). A braking device (15) is attached to the door, and a collector device (17), attached to the rail. The braking device interacts with the collector device to brake the sliding motion of the door when the door approaches an end position. The collector device comprises a base portion (19), attached to the rail, and an arm portion (21) connected to the base portion by means of a hinge (23). A biasing spring (37) is connected to the base and arm portions to urge the arm portion towards the attachment surface, and an adjustment screw (41), attached to the arm portion (21), rests on the rail, such that adjusting the screw pivots the arm portion at the joint. This provides for an accurate adjustment of the collector device.

### TECHNICAL FIELD

The present disclosure relates to a sliding door arrangement comprising at least one sliding door, at least one rail guiding the sliding motion of the door, a braking device attached to one of the door and the rail, and a collector device, attached to the other of the door and the rail. The braking device interacts with the collector device to brake the sliding motion of the door when the door approaches an end position.

### BACKGROUND

Such an arrangement is disclosed for instance in EP-2050907-A2. One issue associated with sliding door arrangements in general is how to simplify installation, especially as this is often carried out by an end user.

### SUMMARY

One object of the present disclosure is therefore to simplify installation. This object is achieved by means of a sliding door arrangement as defined in claim 1. More specifically, a sliding door arrangement of the initially mentioned kind has a collector device, which has a base portion, attached to an attachment surface of the door or the rail, and an arm portion, which is pivotally connected to the base portion by means of a joint/hinge. Further, a biasing arrangement is connected to the base and arm portions, and urges the arm portion to pivot at said joint towards the attachment surface, and an adjustment actuator, which is attached to the arm portion, projects towards the attachment surface and rests on the attachment surface or a surface connected to the attachment surface, such that adjusting the adjustment actuator pivots the arm portion at the joint. This provides for easy and reliable adjustment of the collector device with sufficient accuracy.

The collector device may be attached to the rail, and the braking device may be attached to the door or vice-versa.

The biasing arrangement may include a spring, such as a torsion spring. A helical portion of the spring may be attached to the joint/hinge of the collector device.

The rail may have a U-shaped cross section, in which the collector device may be hidden.

The base portion and the arm portion may be made by injection moulding a plastic material.

The base portion may be attached to the rail by means of a screw, the head of which fits into a channel in the rail. Further, protrusions on a surface of the base portion may extend into this channel.

### BRIEF DESCRIPTION OF THE DRAWINGS

FIG. 1 illustrates schematically a sliding door arrangement.

FIG. 2 shows an exploded view of a collector device.

FIG. 3 shows in partial cross section a collector attached to a rail where the collector interacts with a braking device, attached to a door.

FIG. 4 shows a cross-section through a rail with an attached collector device.

### DETAILED DESCRIPTION

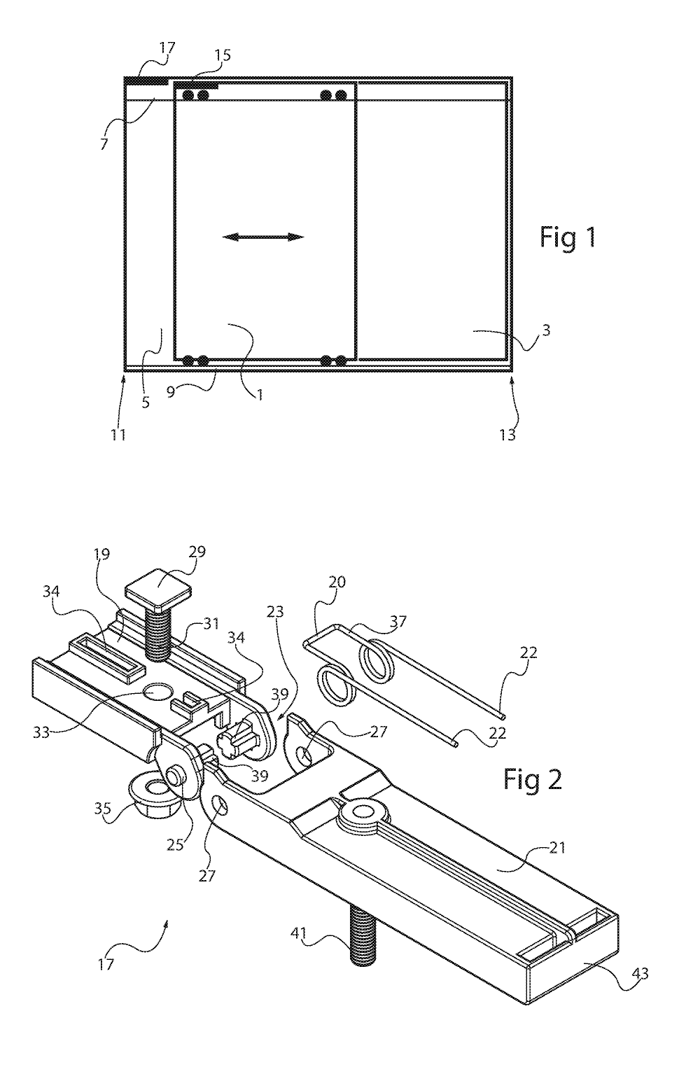

Sliding doors are widely used, for instance to cover an opening to a closet or storage space, or to optionally divide a room into two parts. FIG. 1 illustrates schematically a sliding door arrangement. Usually, two or more doors 1, 3 are used, which together cover an opening 5 with some overlap when closed. A rail arrangement 7, 9, usually employing a top rail 7 and bottom rail 9 may be used to guide the sliding motion of a door between two end positions 11, 13. Alternatives exist where the bottom rail 9 carries the weight of the door, and others where the door is suspended from the top rail 7. Combinations are also possible.

In order to avoid that a sliding door slams e.g. into the side of the opening, a braking device 15 is used that brakes the motion of the door when it is about to reach one of its end positions. Otherwise a door could be damaged, or could damage other objects. The braking device 15 can be combined with a retraction arrangement into an attenuation- and retraction device that breaks the motion of the door and at the same time pulls the door to the end position 11, as is well known per se.

The braking device 15 interacts with a collector device 17 when reaching an end position. Typically, the braking device catches or connects with a protruding part of the collector device, or vice-versa. If the braking device 15 is connected to the door 1, the collector device 17 may be connected to the rail 7 as schematically illustrated in FIG. 1, although the opposite arrangement, where the braking device is connected to the rail 7 and the collector device is connected to the door 1 is also possible.

The present disclosure is mainly concerned with how to accomplish the collector device 17. The collector device may be adjustable in order to deal with manufacturing tolerances and tolerances that arise when the sliding door arrangement is assembled. The sliding door arrangement may often be assembled by an end user, and, if so, the end user should be capable of adjusting the collector device in a reliable and easy way, typically such that it presents a protruding portion that reliably interacts with the braking device.

FIG. 2 shows an exploded view of a collector device 17. The collector device comprises a base portion 19 and an arm portion 21, which is connected to the base portion 19 by means of a joint/hinge 23, which makes the arm portion 21 pivotable with regard to the base portion 19. The base 19 and arm 21 portions may be made from injection-moulded plastic, for instance (30%) glass fibre reinforced polyamide (PA). The joint/hinge 23 may be made up from protruding pins 25 of the base portion 19, which snap into holes 27 in the arm portion 21. Needless to say, the skilled person is capable of providing a hinge or joint in other ways.

The base portion 19 may be attached to a surface of the rail 7, cf. FIG. 1, such that it is fixed with regard to the rail. This may be accomplished by means of a square head screw 29, which is inserted into a channel in the rail 7, matching the head of the screw, wherein a threaded portion 31 of the screw extends through a hole 33 in the collector base portion 19. A nut 35 may be firmly attached to this threaded screw portion 31 on the other side of the base portion 19 in order to attach the base portion 19 to the rail 7. However, it should be noted that other ways of attaching the base portion 19 to the rail 7 are possible, such as e.g. fastening the base portion by means of a screw from below, which is fastened to e.g. the ceiling above the rail.

A biasing or pre-tensioning arrangement in the form of a spring, in the illustrated case a helical torsion spring 37 is used to bias or pre-tension the collector device arm portion 21. A helical part of the spring may for instance be attached to inward extending pins 39 of the base portion 19, and the ends 20, 22 of the spring act on the bottom surfaces, as seen in FIG. 2, of the base 19 and arm 21 portions, respectively. This means that any pivoting movement of the arm portion 21 relative to the base portion 19 clockwise as seen in FIG. 2, away from the rail, will tension the spring 37 to counteract this movement. The joint may be provided with a limiter which gives a maximum flexing of for instance 30° which protects the spring from being permanently deformed.

An adjustment actuator in the form of an adjustment screw 41 is attached to the arm portion 21 by being inserted in a threaded hole. The top end of this screw may when inserted rest on the rail. Thereby, adjusting the screw pivots the arm portion at said hinge. Thanks to this arrangement, turning the adjustment screw 41 moves the free end 43 of the arm portion 21 towards or away from the rail 7, the spring 37 making sure that the end of the adjustment screw remains in contact with the rail 7. Other kinds of adjustment actuators would be possible such as a set of spacers or another device that connect both with the arm portion and the rail.

The user may thus very accurately adjust how much the free end 43 protrudes from the rail, and it is the free end 43 that interacts with a braking device, or an attenuation- and retraction device.

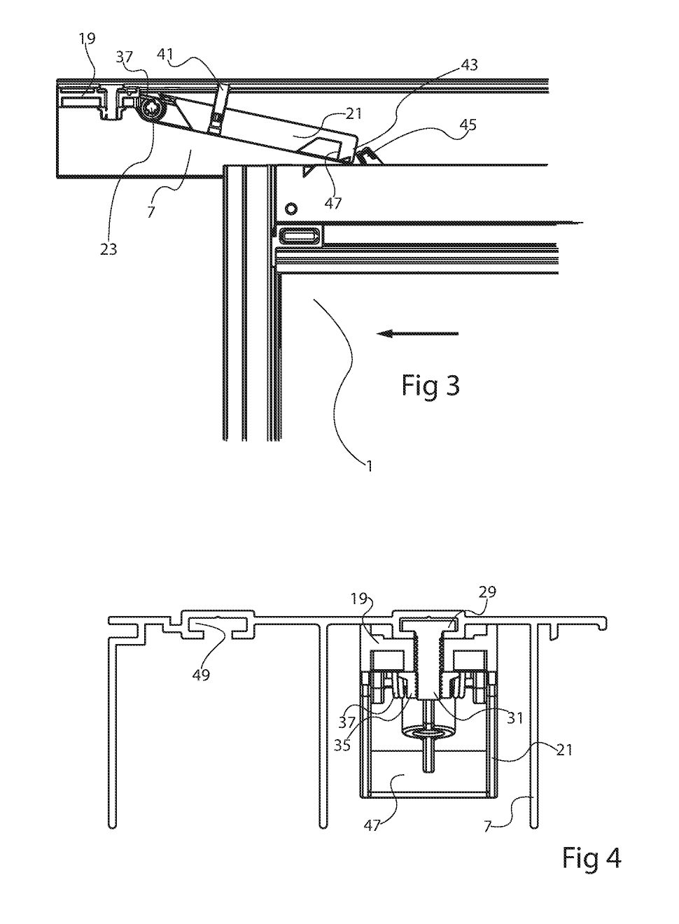

This is illustrated in FIG. 3, which shows a collector 19, 21, 23 attached to a rail 7 that interacts with a braking device, a protruding portion 45 of which is visible in FIG. 3. The collector device and the rail are shown in cross section. In the illustrated case, the door rests on wheels running on a bottom rail (not shown). The top rail 7 has an upside-down U-shaped cross section across its longitudinal direction. Wheels attached to the top part of the door may run on the inside of the legs of the U-shape in order to stabilise the top of the door laterally with regard to the travelling direction of the door 1. The collector device can be hidden inside the U-shaped cross section of the rail 7.

FIG. 3 shows how the free end surface 43 of the collector arm portion 21 can interact very accurately with a protruding portion 45 of the braking device, thanks to the adjusting arrangement. The adjustment screw 41 rests on the rail 7, and the spring 37 urges the arm portion 21 upwards in order to obtain this. The user can adjust the screw e.g. by means of an Allen key. As illustrated, the arm portion 21 may also provide a surface 47 facing towards the adjacent end of the rail, this surface being adapted to interact with a retraction device that may pull the door 7 to the end position.

FIG. 4 shows a cross-section through a rail 7 with an attached collector device, as seen from the adjacent end of the rail. The rail 7 is a double rail with U-shaped openings for two sliding doors. As illustrated, each opening has a channel 49, where the head of a screw 29 fits in the channel, as previously mentioned. The channel 49 has an opening with a narrower width as compared to the channel as a whole, such that the screw head can rest on the opening. The rail 7 may be made of extruded aluminium and may thus substantially have the same cross section along its length. Therefore, the position of the collector 17 along the length of the rail may be easily adjusted by slightly loosening the nut 35 and sliding the base portion 19 to a desired position on the rail 7. The collector device may also be easily replaced, even without removing the screw 29.

As shown in FIG. 2, the upper side of the base portion 19 may be provided with projections 34 that enter the channel 49 to provide a steering function that aligns the longitudinal direction of the collector device 17 with the one of the rail 7.

The present disclosure is not restricted to the examples given above, and may be varied and altered in different ways within the scope of the appended claims.

1. A sliding door arrangement comprising at least one sliding door, at least one rail configured to guide the sliding motion of the door, a braking device attached to one of the door and the rail, and a collector device, attached to the other of the door and the rail, the braking device being configured to interact with the collector device to brake the sliding motion of the door when the door approaches an end position wherein the collector device comprises:
a base portion, attached to an attachment surface of said door or said rail;
an arm portion pivotally connected to said base portion by means of a joint;
a biasing arrangement connected to the base portion and the arm portion, the biasing arrangement urging the arm portion to pivot at said joint towards the attachment surface; and
an adjustment actuator which is configured to adjustably project from the arm portion towards the attachment surface and rest against the attachment surface or a surface connected to the attachment surface, wherein adjusting the adjustment actuator pivots the arm portion at said joint.

2. A sliding door arrangement according to claim 1, wherein the collector device is attached to the rail.

3. A sliding door arrangement according to claim 1, wherein the collector device is attached to the door.

4. A sliding door arrangement according to claim 1, wherein the biasing arrangement includes a spring.

5. A sliding door arrangement according to claim 4, wherein the spring is a torsion spring with a helical portion attached to the joint of the collector device.

6. A sliding door arrangement according to claim 1, wherein the rail has a U-shaped cross section in which the collector device is hidden from view.

7. A sliding door arrangement according to claim 1, wherein the base and arm portions are made of an injection molded plastic material.

8. A sliding door arrangement according to claim 2, wherein the base portion is attached to the rail by means of a screw, the head of which fits into a channel in the rail.

9. A sliding door arrangement according to claim 8, wherein protrusions on a surface of the base portion extend into said channel.

10. A sliding door arrangement comprising:
at least a first part and a second part, the first part comprising one of a sliding door and a rail for guiding the sliding motion of the sliding door, and the second part comprising the other of the sliding door and the rail;
a braking device attached to the first part and a collector device attached to the second part, the braking device being configured to interact with the collector device to brake the sliding motion of the door when the door approaches an end position;
wherein the collector device comprises:
a base attached to the second part;
an arm pivotally coupled with the base at one end, with a free end biased towards the first part, away from the second part; and
an adjustment actuator projecting from the arm portion and toward the first part, wherein adjusting the adjustment actuator pivots the arm portion when the adjustment actuator engages the first part.

11. The sliding door arrangement according to claim 10, further comprising a spring for biasing the arm portion toward the first part.

12. A sliding door arrangement according to claim 11, wherein the spring is comprised of a torsion spring with a helical portion attached to the joint of the collector device.

13. A sliding door arrangement of claim 11, wherein the second part comprises a rail, and the rail has a U-shaped cross section in which the collector device is hidden.

14. A sliding door arrangement according to claim 11, wherein the base and arm are made from an injection molded plastic material.

15. A sliding door arrangement according to claim 11, wherein the base is attached to the rail by means of a screw having a head that fits into a channel in the rail.

16. A sliding door arrangement according to claim 15, wherein the base further comprises protrusions extending into the channel.
